(19) United States
(12) Patent Application Publication
(10) Pub. No.: US 2025/0149030 A1
(43) Pub. Date: May 8, 2025

(54) METHOD FOR OPERATING A HEARING AID SYSTEM AND HEARING AID SYSTEM

(71) Applicant: Sivantos Pte. Ltd., Singapore (SG)

(72) Inventor: Julius KRIEG, Olpe (DE)

(21) Appl. No.: 18/939,940

(22) Filed: Nov. 7, 2024

(30) Foreign Application Priority Data
Nov. 7, 2023 (DE) 10 2023 211 026.1

(51) Int. Cl. G10L 15/183; G06F 3/01; G10L 15/22

(52) U.S. Cl. CPC G10L 15/183; G06F 3/015; G06F 3/017; G10L 15/22

(57) ABSTRACT

A method for operating hearing aid systems includes a receiving unit receiving and converting speech information into a speech signal, a speech recognition unit converting a speech signal into a text signal, a prompt unit generating a context-dependent prompt for a natural language processing unit, a triggering unit triggering the prompt unit as required and specifying a stored context, an evaluation unit evaluating a prompt by a natural language processing unit and generating an output signal, and an output unit outputting an output signal to a user. Upon triggering the triggering unit, at least one section of the speech signal is converted into a text signal by the speech recognition unit, a prompt is generated for the natural language processing unit by the stored context and text signal, the natural language processing unit generates an output signal based on the prompt, and the output unit outputs the output signal.

### CROSS-REFERENCE TO RELATED APPLICATION

This application claims the priority, under 35 U.S.C. § 119, of German Patent Application DE 10 2023 211 026.1, filed Nov. 7, 2023; the prior application is herewith incorporated by reference in its entirety.

### FIELD AND BACKGROUND OF THE INVENTION

The invention relates to a method for operating a hearing aid system and a hearing aid system for carrying out the method.

The term “hearing aid system” or “hearing aid device” refers to a single device or group of devices and, if applicable, non-physical functional units which together provide (hearing) functions to a person using the hearing aid system (hereafter referred to as “(hearing aid system) user” or “(hearing aid system) operator”). In the simplest case, the hearing aid system can be formed of a single hearing device. Alternatively, the hearing aid system can include two interacting hearing devices for treating both ears of the user. In this case, it is referred to as a “binaural hearing system” or “binaural hearing device.” In addition, the hearing aid system can include components external to the hearing device, for example an auxiliary device such as a smartphone or a smartphone app.

A hearing device generally refers to as an electronic device that supports the hearing capacity of a person wearing the hearing device. In particular, the invention relates to a hearing device which is configured to compensate partially or wholly for a hearing loss of a hearing impaired user. Such a hearing device is also called a “hearing aid” (HA). In addition, there are hearing aids that protect or improve the hearing capacity of normal hearing users, for example in complex listening situations to enable improved speech comprehension. Such devices are also referred to as “Personal Sound Amplification Products” (for short: PSAP). Finally, in the sense used herein, the term “hearing device” also covers headphones worn on or in the ear (wired or wireless and with or without active noise canceling), headsets, etc., as well as implantable hearing aids, such as cochlear implants.

Hearing devices in general, and hearing aids in particular, are usually configured to be worn on the head and in particular in or on a user's ear, in particular as a behind-the-ear (BTE) or in-the-ear (ITE) device. With regard to their internal structure, hearing aids normally have at least one output transducer, which converts an output audio signal supplied for the purpose of output into a signal perceptible to the user as sound, and outputs the latter to the user.

In most cases, the output transducer is configured as an electro-acoustic transducer, which converts the (electrical) output audio signal into airborne sound, which is delivered into the ear canal of the user. In a hearing aid worn behind the ear, the output transducer, also known as a “receiver,” is usually integrated in a housing of the hearing aid outside the ear. In this case, the sound emitted by the output transducer is passed into the user's ear canal by a sound tube. Alternatively, the output transducer may also be disposed in the ear canal, and thus outside the housing worn behind the ear. Such hearing aids are also referred to as RIC devices after the term “receiver in channel.” Hearing aids worn in the ear, which are so small that they do not extend externally beyond the ear canal, are also referred to as CIC devices (from the term “Completely in Canal”).

In other configurations, the output transducer can also be configured as an electro-mechanical transducer, which converts the output audio signal into structure-borne sound (vibrations), which is delivered, for example, into the skull of the user. There are also implantable hearing aids, in particular cochlear implants, and hearing aids the output transducers of which directly stimulate the user's auditory nerve.

In addition to the output transducer, a hearing device often has at least one (acousto-electric) input transducer. When the hearing device is in operation, the or each input transducer captures airborne sound from the environment of the hearing device and converts this airborne sound into an input audio signal (i.e., an electrical signal that carries information about the ambient sound). This input audio signal—also known as a “captured sound signal”—is regularly output to the user him/herself in original or processed form, e.g. to implement a so-called transparency mode in a headphone, for active noise cancellation or—e.g. in a hearing aid—to achieve an improved sound perception by the user.

In addition, a hearing device often has a signal processing unit (signal processor). The signal processing unit processes the or each input audio signal (i.e. modified in terms of sound information). The signal processing unit outputs a suitably processed audio signal (also referred to as “output audio signal” or “modified sound signal”) to the output transducer and/or to an external device.

Hearing aids offer various additional (hearing/hearing aid) functions, for example from the field of signal processing, which can provide a hearing benefit for a hearing aid user (or hearing aid wearer, HAW). Examples of such functions could be: recognition of the speaker's own voice (own voice detection, OVD), speech recognition or voice activity detection (VAD), active noise reduction (ANR), active occlusion reduction (AOR); streaming of audio information (e.g. music), detection of different body signals (e.g. fitness); detection of certain events and reactions to them (e.g. fall detection-when a user falls down, an alarm is sent), etc. Functions such as these are often implemented as software or processing algorithms of the signal processing device.

The handling of conversational situations is one of the core problems in the application of hearing aid systems or hearing aids. This is due mainly to the fact that the user of a hearing aid system often receives important information in a face-to-face conversation. Purely from the point of view of the most reliable transfer of information possible, it is therefore appropriate to attach particular importance to the intelligibility of speech for the user of a hearing aid system. On the other hand, it is precisely speech intelligibility that is often adversely affected by the fact that typical speech situations are superimposed with a high proportion of extraneous noises, such as may be the case, for example, in a conversation with several conversation partners who do not always speak one after the other in turn, or in a dialogue in a closed room, in which other groups of people contribute to a higher noise level due to their own conversations (so-called “cocktail party” listening situation).

When listening to a conversation, the user may sometimes not fully understand the conversation or parts of the conversation acoustically and/or linguistically. This makes it necessary, for example, for the user to ask his/her interlocutor(s) to repeat parts of the conversation, to speak more clearly, or to phrase utterances in a different way. In particular in conversation situations where the user is only listening as a passive (non-speaking) participant in a conversation, they may hesitate to interrupt the active speakers too often or to request repetitions. This means that there is a need to improve the acoustic and/or content-related speech intelligibility in such conversational situations.

### SUMMARY OF THE INVENTION

It is accordingly an object of the invention to provide a particularly suitable method for operating a hearing aid system, which overcomes the hereinafore-mentioned disadvantages of the heretofore-known methods of this general type. In particular, an acoustic and/or content-related speech intelligibility in passive conversational situations should be improved. An additional object of the invention is to specify a hearing aid system that is particularly suitable for carrying out the method.

With the foregoing and other objects in view there is provided, in accordance with the invention, a method for operating a hearing aid system, which comprises providing:
a receiving unit for receiving speech information and converting it into a speech signal,
a speech recognition unit for converting a speech signal into a text signal,
a prompt unit for generating a context-dependent prompt for a natural language processing unit,
a triggering unit for triggering the prompt unit as required and specifying a stored context,
an evaluation unit for evaluating a prompt by using a natural language processing unit and for generating an output signal, and
an output unit for outputting an output signal to a user,
the speech information is received and converted into a speech signal, and
when the triggering unit is triggered:
a) at least one section of the speech signal is converted into a text signal by the speech recognition unit,
b) a prompt is generated for the natural language processing unit by the stored context and the text signal,
c) the natural language processing unit generates an output signal based on the prompt, and
d) the output signal is output by the output unit.

With the objects of the invention in view, there is concomitantly provided a hearing aid system for carrying out the method, comprising:
a receiving unit for receiving speech information and converting it into a speech signal,
a speech recognition unit for converting a speech signal into a text signal,
a prompt unit for generating a context-dependent prompt for a natural language processing unit,
a triggering unit for triggering the prompt unit as required and specifying a stored context,
an evaluation unit for evaluating a prompt by a natural language processing unit and for generating an output signal, and
an output unit for outputting an output signal to a user.

Advantageous embodiments and refinements form the subject matter of the dependent claims.

The advantages and embodiments mentioned in relation to the method are also applicable mutatis mutandis to the hearing aid system and vice versa. Where method steps are described in the following, advantageous configurations for the hearing aid system are obtained in particular by the fact that the latter is configured to execute one or more of these method steps.

The conjunction “and/or” here and in the following is to be understood to mean that features linked by this conjunction can be implemented both jointly and as alternatives to each other.

The method according to the invention is intended for operating a hearing aid system, in particular a hearing aid device, and is also suitable and configured for this purpose.

The hearing aid system has a receiving unit for receiving speech information and converting it into a speech signal.

A “speech signal” here and in the following is understood to mean, in particular, an acoustic or electrical signal which is capable of transmitting, storing or processing oral or spoken (speech) information. Such a speech signal contains in particular information generated by the human voice, which may include words, sentences, sounds or other vocal utterances. A speech signal can exist in various forms, including analog sound waves, digital audio data, or other electrical signals that encode or transmit speech information.

The receiving unit includes, for example, an acousto-electric transducer, which captures acoustic signals from an environment and converts them into a digital input signal. Preferably, the transducer is configured in this case as a microphone. In addition or alternatively, the receiving unit may, for example, have a transceiver (RF receiver, T-coil, . . . ) for receiving wireless radio signals, and from this generate a corresponding input signal.

The in particular digital or electrical speech signal is usually a part of the received input signal. For example, the receiving unit has a voice activity detection unit (VAD) to isolate or separate the speech signal from the rest of the input signal. Voice activity detection is in particular the (signal-based) detection of the presence or absence of human speech. In other words, the speech signal is preferably the (digital or electrical) signal output by a voice activity detection system.

The hearing aid system further includes a speech recognition unit for converting or transcribing a speech signal into a text signal.

A “text signal” as used here is the speech signal converted into text form.

The speech recognition unit is constructed and configured to convert the speech signal into machine-readable text automatically. The speech recognition unit uses, for example, linguistic models, audio signal processing and trained artificial neural networks to identify, transcribe and convert spoken words and sentences into written form. Various aspects of the acoustic and phonetic properties of the speech are analyzed and converted into text form.

The hearing aid system additionally has an evaluation unit for evaluating a prompt by using natural language processing and for generating an output signal. The prompt is evaluated and/or processed by using the natural language processing unit, wherein the output signal is the signal output by the natural language processing unit.

A “prompt” here and in the following is in particular a text-based input or input prompt, which serves to stimulate the natural language processing unit to provide specific information, answers or generated content from the text signal. A prompt can be in the form of a sentence, a question, a request or a text fragment, and is used to initiate a desired linguistic response or output of the evaluation unit. For example, a prompt is processed by analyzing the content, followed by algorithmic response generation or response feedback by the natural language processing unit.

The term “natural language processing” (NLP) is understood here and in the following to mean, in particular, an application of computer algorithms and techniques for the analysis and processing of natural language in order to extract, understand or generate semantic, syntactic and pragmatic information from textual or linguistic data sources. This includes the use of generative artificial intelligence (AI), large language models (LLM) and other linguistic processing systems to perform tasks such as text classification, automated text generation, sentiment analysis, language comprehension, and similar tasks efficiently and accurately.

The natural language processing system is trained using common AI and NLP training methods. A typical example is the training of an LLM such as GPT-3, in which an immense amount of text data from the Internet is used as a training corpus. The model adjusts its weights and parameters to learn probabilities for the occurrence of words and word combinations. This method enables the model to respond to complex natural language input by generating context-dependent and meaningful responses or generated texts.

The evaluation unit is, for example, a server or a data cloud (or cloud) on which the natural language processing, for example in the form of an algorithm or a software, is implemented.

A data cloud, also known as the cloud or computing cloud, is understood here and in the following in particular to mean a model, which, if required-usually via the Internet and device-independently-provides shared computer resources as a service, for example in the form of servers, data storage or applications in real time. The provision and use of these computer resources is defined and usually takes place via a programming interface or for users via a website or a program (e.g. app).

The hearing aid system also includes a prompt unit to generate or provide a context-sensitive prompt. The prompt is used, based on the given context and the text signal, as an input or input signal for the natural language processing of the evaluation unit in order to generate the output signal. Expressed in simple terms, with regard to the natural language processing, the text signal is “What should be processed” and the context is “How should it be processed.” The text signal is preferably integrated in the prompt, so the text signal is part of the context-dependently generated prompt.

A “prompt unit” is understood here and in the following to mean in particular a device, preferably an algorithm or a piece of software, which is constructed and configured to automatically or manually generate linguistic input prompts (or prompts) based on a predetermined context and the text signal, in order to achieve a specific desired result or desired processing of natural language. The prompt unit can use linguistic rules and algorithms to create prompts that are tailored to the needs and objectives of a particular application or a particular task.

The hearing aid system also includes a triggering unit for triggering the prompt unit as required and specifying a stored context. In particular, “triggering as required” is understood here to mean that a user of the hearing aid system can activate or trigger the triggering unit whenever they need to. The triggering unit is thus constructed and configured to be activated or triggered depending on a response or an action by the user.

A “specification of a stored context” is understood here to mean in particular that the triggering or activation of the triggering unit is linked to a specific or stored context, which is used to generate the prompt. A predefined context is thus stored in the hearing system, on the basis of which the prompt is generated. Alternatively, a prompt which is predefined or pre-formulated with regard to the context can also be stored here.

For example, a context here is understood to mean a request function, i.e. a type of evaluation for the natural language processing desired by the user. Typical questions for a user during a conversational or listening situation may include: “how?,” “what?” or more specific questions such as “who?,” “when?,” questions about certain contents of a sentence, or the request to repeat or paraphrase at least part of a sentence. Such questions are assigned to a context according to the method, so that the user can trigger the context or the question as required in order to effect a desired evaluation of the speech signal or text signal using the natural language processing system by using the resulting prompt.

The context may be, for example, that the user has not fully understood acoustically the speech signal or parts thereof, wherein as a prompt, for example, “Repeat what you just said” or “Extract the important information from what has just been said” is generated. For example, as a context it may also be stored that the user has not fully understood the speech signal or parts thereof in terms of content, wherein as the prompt, for example, “Summarize what has just been said in different words” or “Explain what has just been said in different words” is generated.

It is conceivable, for example, that the text signal and the prompt are fed into the natural language processing unit as separate inputs or input signals. However, the text signal or the transcribed speech signal is preferably integrated into the context-dependent prompt when it is generated, for example in the sense of “What are the keywords in the following text: (Text signal)” or by replacing the passage “what has just been said” with the text signal in the examples described above.

According to the method, speech information is received and converted into a speech signal. The speech signal originates, for example, from a speech utterance which is spoken by a speaker in the vicinity of the (hearing aid system) user, and is detected by the receiving unit of the hearing aid system. Alternatively, the utterance can also come from a radio signal, for example a Bluetooth signal or a mobile network signal (e.g. media streaming or telephone conversations), which is transmitted to the receiving unit via an external auxiliary device, such as a smartphone.

When the user triggers the triggering unit, the speech signal—or at least a section of the speech signal—is converted into a text signal or transcribed by using the speech recognition unit.

If the triggering unit is triggered by the user, the triggering unit continues to generate a prompt for the natural language processing unit. The prompt is generated in this case with regard to a stored context based on the text signal, which is linked to the triggering of the triggering unit. Preferably, in addition to the context and the text signal, the prompt unit also takes into account a trigger time of the trigger. Thus, for generating the prompt the prompt unit available also has at its disposal a time related to the text signal or at least an indication, which connects the trigger and text signal to each other. This trigger time can be measured or determined in absolute or relative terms.

The prompt is fed into the natural language processing unit, which generates an output signal from it. The natural language processing effectively processes (modifies, interprets, paraphrases, . . . ) the information in the text signal on the basis of the content of the context or an associated work or evaluation instruction, and generates the output signal as a result.

The output signal is finally output by the output unit. As a result, a particularly suitable method for operating a hearing aid system is implemented.

When listening to a conversation, requests (such as “Please repeat,” “Please say that again/differently,” “Please speak more clearly,” . . . ) can often cause comprehension problems (e.g. “I don't understand this”) or questions (e.g. “Hey?,” “What?,” “How?,” “Who?,” “When?,” “Where?,” “Whose?,” . . . ) for a user. This is particularly the case if the user is only listening to a conversation as a passive participant and does not want to interrupt the active speakers too often.

According to the invention, in such a case the user can trigger a conversion of speech into text and the text-based analysis of a current utterance by the natural language processing unit. For example, the analysis result (output signal) helps to clarify a sentence and/or increase the speech intelligibility.

The generated response, which is presented as an output signal via the output unit, depends on the current or recently spoken content (i.e. the content of the speech signal), the time of activation of the function or triggering unit, and the type of context or prompt that is triggered or generated.

Depending on the prompt used, the output signal can be, for example, an identification of relevant parts of an utterance, or to repeat an utterance on request after noise cancelation. For example, when listening to a speech utterance, the user can trigger a request function. This is intended to have the most important speech fragments or a resulting processing outcome repeated more clearly in order to improve speech intelligibility for a hearing impaired user.

For example, the last misunderstood spoken sentence and/or the transcribed conversation (optionally with speaker assignment) of the last few minutes can be specified in the prompt. If, for example, it mentions terms or relations, it is assumed, for example, that the user has already understood them and that they can be referred to in the response or the output signal.

The method according to the invention is intended in particular for listening situations which are not one-to-one scenarios (i.e. the user is in particular only a passive spectator/listener). The presentation or output of the output signal by the output unit is preferably carried out in a manner that is unobtrusive for the user, while the listening situation or the conversation continues.

In an advantageous refinement, the triggering unit can be triggered in response to at least two different trigger types. In other words, the triggering unit can be activated or triggered in different ways. Each type of trigger or manner of triggering is associated with a different context or resulting prompt for the natural language processing. If the triggering unit is triggered on a first type of trigger, the prompt unit thus generates a prompt for a first context (e.g. linguistic comprehension problem), and if the triggering unit is triggered on a different type of trigger, the prompt unit generates a prompt for a different context (e.g. content-related comprehension problem). Thus, in the activation or triggering of the triggering unit, it is possible to code how the user would like to have the speech signal evaluated by the natural language processing unit. In particular, the user can choose freely between different language evaluations or processing types as required. The different types of triggering create additional freedoms with regard to the evaluation.

Preferably, the triggering unit can be triggered in this case in response to a number of different trigger types, each trigger type being linked to a different context or a different resulting prompt. For example, it is conceivable here that the user can adapt and modify the contexts or prompts associated with the trigger types, for example using a smartphone app.

In a preferred embodiment, a user gesture is used as at least one trigger type. In other words, the triggering unit can be triggered by a gesture. For this purpose, the triggering unit has a gesture recognizer, which detects the user's gestures and evaluates whether they are linked to a trigger type and/or a context or prompt. A gesture here is understood to mean a body movement of the user, in particular a movement of an arm and/or a hand and/or the head.

The triggering of the trigger unit can be effected by a gesture (e.g. registered by a sensor in the hearing aid, such as LIDAR, or another portable device wirelessly connected to the hearing aid, such as an electronic wrist strap), a physical button push, a virtual button push in a smartphone app, or a speech command. Different keys/gestures/commands can be coded for different trigger types or contexts/prompts.

The output signal can be issued, for example, as an audio or sound signal which is generated by an electro-acoustic transducer (loudspeaker). In other words, in a preferred embodiment the output signal is audible. In a conceivable embodiment, a certain section of the recorded speech signal (audio input signal) or a combination of at least two sections of the speech signal is generated as an output signal. For example, a recording of the speech signal or one or more sections of it is played back. In cases where more complex audio signal processing is required, the output signal may be a speech signal generated as a result of a text-to-speech algorithm. In this case it is conceivable, for example, that the generated speech utterance is synthesized by a text-to-speech engine by imitating at least one voice or location feature of the original speaker. As an alternative to imitating the original speaker, a default voice of an assistant can also be used. For example, a plurality of such assistance voices are stored, wherein depending on the listening situation, the assistance voice is selected which stands out best from the listening or conversational situation.

The output signal can be additionally or alternatively displayed optically by a display unit, for example a screen (e.g. of a cellphone, smartphone, tablet, . . . ) in the form of text. It is possible, for example, that a transcribed speech signal is displayed on the display unit. This allows the user to check later or to ensure, for example by viewing the generated text, that they have understood the utterance correctly. Preferably, the user can also select or highlight difficult-to-understand speech episodes or speech signal sections. These selected or highlighted sections can then be used, for example, as training data for the prompt unit and/or the natural language processing unit or the evaluation unit, in order to better adapt the evaluation or the resulting output signal to the needs of the individual user as the service life of the system increases.

In this way, the hearing aid system, which best understands the user's needs and has unlimited patience for repeated requests, can improve the speech intelligibility in passive conversational or listening situations in an increasingly reliable and user-friendly manner.

In a convenient configuration, a hearing profile for the user is stored in the hearing system, wherein the prompt (or the context) is generated in accordance with the hearing profile. For example, this allows a targeted identification of parts of an utterance that are difficult to understand for a user with a specific hearing profile.

A “hearing profile” here and in the following is in particular an individual acoustic characterization of a user with regard to his/her hearing ability. For example, this hearing profile is created on the basis of audiological examinations and measurements and preferably takes into account the specific hearing impairments, hearing habits and preferences of the user. The hearing profile can include information about individual hearing thresholds, sensitivity to different frequencies, and preferred sound qualities and processing settings for optimal hearing enhancement. The use of a hearing profile allows the hearing system to specifically adjust the sound of an output audio signal to provide a customized and effective hearing support for the user.

For example, it is possible to specify, based on the stored hearing profile, a threshold value which is compared, for example, with a (volume or signal) level of the speech/input signal. For example, it is conceivable that different prompts will be generated for the same context, depending on whether the intelligibility reaches or fails to reach the threshold.

In another variant, the text from which an output signal is to be derived can be generated depending on the user's hearing profile. For example, if the intelligibility for a particular word is below a predefined threshold, it can be replaced by another word, preferably a synonym. The substitution can be performed directly by the natural language processing (by modifying/adjusting the prompt accordingly) or in a separate, subsequent step. For example, a server external to the hearing aid system can be used to create substitutions.

For example, the hearing impairment could be located on a higher processing level, i.e. not just an abnormality in the hearing curve. For example, if the user cannot distinguish some phonemes well, the prompt could receive an individualized list of problematic phonemes so that the natural language processing unit finds a synonym for a word used that has low intelligibility.

An additional or further aspect of the invention provides that the hearing aid system includes a physiological sensor for detecting information about a body state of the user, wherein the output signal is adjusted based on sensor data of the physiological sensor. In addition or alternatively, the sensor data from the physiological sensor is compared with a stored threshold value, wherein when the threshold value is reached or exceeded, the triggering unit is triggered.

A “physiological sensor” here and in the following is understood to mean, in particular, an electronic or mechanical device or instrument which is constructed and configured to perform measurements or recordings of physiological parameters of the human body. These parameters can include a wide range, such as, but not limited to, heart rate, blood pressure, body temperature, blood oxygen saturation, electrocardiogram (ECG) signals, electroencephalogram (EEG) signals, skin conductivity, muscle activity, respiratory rate, heart rate variability, and other biological or physiological quantities.

The physiological sensor can exist in various forms, including electrical sensors, optical sensors, mechanical sensors, and other sensor technologies. The sensor data collected by the physiological sensor may be recorded or transmitted in real time to adjust the signal characteristics of the output signal and/or to be used as a trigger criterion or type of trigger for the triggering unit.

In a variant with an additional physiological sensor (e.g., brain waves, head alignment, facial muscle activation), the data registered by the sensor during the speech utterance can be used to identify parts of the utterance that are incomprehensible or incomprehensible to the user. In other words, speech comprehension or a measure of speech comprehension is determined from the sensor data of the physiological sensor. Based on these observations, the output signal or context or prompt can be adapted to increase speech intelligibility. In another or additional variant, such data registered by the sensors can be used to trigger activation of the triggering unit without an additional gesture, if their magnitude exceeds a predefined threshold value.

In a preferred embodiment, during operation a predetermined duration of the speech signal is stored and substantially continuously updated until the triggering unit is triggered, wherein the speech recognition unit uses the stored speech signal. The hearing aid system or the receiving unit thus includes, for example, a buffer for recording and temporarily storing the speech utterance in order to further process the stored speech signal when the triggering unit is triggered. For example, the hearing aid system has a rolling buffer as a digital data storage system, which continuously records the last few seconds of a received spoken speech signal (or text signal) and automatically deletes the oldest data to make space for the most recent recordings. This mechanism allows a constantly updated and limited history of spoken utterances to be maintained in real time without wasting unnecessary resources on storing irrelevant information.

This means that when the triggering unit is triggered, instead of the complete speech utterance being evaluated or processed as a speech signal, only the last few seconds are processed. This creates further freedom for the method to take into account the trigger time at which the triggering unit was activated in relation to the spoken utterance.

For example, the last 45 s (seconds), 30 s, 20 s, 15 s, or 10 s are buffered and continuously updated. This comparatively short-term storage ensures that when the triggering unit is triggered, the current speech content of the speech signal is analyzed and processed, enabling important information to the user to be recognized and processed more reliably. This enables particularly reliable, customized output signals to be generated in response to the trigger based on the context/prompt and the time at which the triggering unit is set.

An additional or further aspect provides that utterances that occurred further in the past (e.g. in the last 30 s to 45 s) are used as context to process a current utterance (in the last 0 s to 5 s). For example, more meaningful keywords can be generated if the subject area from an utterance that has been made at an earlier time can be restricted by the natural language processing.

Thus, for example, a ‘prompter’ functionality can be implemented, in which the important keywords of the last 15 s or less are generated as the output signal for understanding speech uttered by a third person, based on the exact knowledge of the user, their vocabulary and their mental and/or hearing abilities. Preferably, complete summaries are not necessary, but only enough clues or keywords to be able to rejoin a conversation.

Depending on the time of triggering in relation to the utterance or a keyword contained therein, an utterance in the speech signal is converted into text. For example, a text-based prompt is created together with the transcribed speech based on the time and (trigger) type of the activation of the triggering unit (i.e. the context). The natural language processing unit of the processing unit is used to create a specific response as an output signal, which optimally fulfils the user's request.

In a conceivable application, at least one section of the text signal is paraphrased for the output signal in the course of the natural language processing. In other words, a corresponding prompt is generated so that the data processing generates an appropriately paraphrased text signal as the output signal.

The natural language processing thus includes the ability to perform effective paraphrasing of individual words or text fragments. This process involves analyzing the semantic meaning of a given word or text fragment and generating an alternative form that conveys a similar or equivalent meaning. This process can be used to increase intelligibility or to meet certain linguistic requirements, such as rephrasing technical terms into generally understandable language. This allows keywords of an utterance to be paraphrased and less understandable words to be substituted. For example, it is also possible to replace foreign words, technical terms, idioms, foreign language expressions, etc. with synonyms or simplified expressions, thereby improving the speech intelligibility of the utterance, especially with regard to content-related comprehension problems for the user.

The hearing aid system according to the invention is configured for carrying out a method described above, and is suitable and configured for this purpose. The hearing aid system has a receiving unit for receiving speech information and converting it into a speech signal, a speech recognition unit for converting a speech signal into a text signal, a prompt unit for generating a context-dependent prompt for a natural language processing unit, an evaluation unit for evaluating a prompt by using natural language processing and for generating an output signal, an output unit for outputting an output signal to a user, and a triggering unit for triggering the prompt unit as needed and specifying a stored context.

The individual components or units may be implemented, for example, on one or more processors or controllers, which are located, for example, in a hearing aid and/or a local computer and/or a portable computer device and/or a server.

In a conceivable embodiment the hearing aid system has at least one hearing aid and a remote interaction unit coupled to it for signal transmission, in particular a peripheral device, as well as a network connected to this for signal transmission. In the preferred application, the hearing aid of the hearing aid system is a hearing aid configured for the treatment of hearing impaired people. In principle, however, the invention is also applicable to a hearing aid system with a “personal sound amplification device.” The hearing instrument is particularly in the form of one of the aforementioned configurations, in particular as a BTE, RIC, ITE or CIC device. The hearing instrument may also be an implantable or vibrotactile hearing aid.

The hearing aid is configured to capture sound signals from the environment and output them to the user. The hearing aid has a (hearing) aid housing in which, for example, an input transducer, a signal processing device, and an output transducer are accommodated. The hearing aid housing is configured in such a way that it can be worn by the user on the head and near the ear, e.g. in the ear, on the ear, or behind the ear.

The hearing aid has at least one acousto-electric input transducer, in particular a microphone, which is part of the receiving unit of the hearing aid system. The input transducer captures sound signals (noises, tones, speech, etc.) from the environment during operation of the hearing aid and converts them into an electrical input signal (acoustic data). The hearing aid further includes a speech recognition or voice activity detection unit (VAD) as part of the receiving unit, for example as part of the signal processing device, which generates a speech signal from the input signal or the acoustic data.

The, in particular, electro-acoustic output transducer is configured, for example, as a (miniature) loudspeaker to generate an acoustic output signal from an audio signal generated by the signal processing device. The output transducer can be part of the output unit.

The prompt unit and/or the speech recognition unit may be integrated into the hearing aid or into the signal processing device. Preferably, however, the prompt unit and the speech recognition unit are each part of the remote interaction unit. The remote interaction unit can be integrated into or implemented in a peripheral device detached from the hearing aid, e.g. in a smartphone or tablet computer. Preferably, the remote interaction unit is configured in the form of an app associated with the hearing aid and interacting with it, wherein the app is installed according to its intended purpose on a smartphone or other mobile device. In this case, the smartphone or mobile device is normally not itself a part of the hearing system, but is only used by the latter as an external resource.

The signal-transmission coupling between the hearing aid and the remote interaction unit is preferably wireless. A wireless communication link, for example a radio link, is thus formed between the components. For this purpose, the hearing aid and the electronic device have corresponding transceivers for data and signal exchange. For example, the transceiver can be a radio frequency transceiver (e.g. LoRa, Bluetooth, WiFi, UWB, WLAN). A transceiver for signal transmission via magnetic induction (e.g. T-Coil, etc.) or via the cellular radio network is also conceivable. The speech signal generated by the receiving unit or the voice activity detection is transmitted to the remote interaction unit via a wireless communication link, so that the demands on the signal processing device are reduced.

The triggering unit is in this case integrated into the hearing aid and/or into the remote interaction unit, for example. For example, a switch or button for triggering the triggering unit may be provided on the hearing aid, in which case a corresponding trigger command or trigger signal is sent to the prompt unit and speech recognition unit. The hearing aid can further include a tap detection device, that is, a device for detecting or recording a tapping movement or tapping gesture by the user to trigger the triggering unit. In addition or alternatively, the triggering unit can be triggered from the remote interaction unit, for example by optical gesture recognition using a smartphone camera or by touching a touch display.

The triggering unit may, for example, have multiple different trigger types, wherein the trigger types or their actuation can also be distributed over the hearing aid and the remote interaction unit. The trigger types are each linked to a stored context.

When the triggering unit is triggered, the remote interaction unit generates a text signal from the transmitted speech signal by using the speech recognition unit. For example, a prompt is generated by the prompt unit based on the context and the text signal. The content of the prompt therefore depends on the triggered context and the text signal.

The prompt (and, optionally, the text signal) is transmitted to the evaluation unit. The evaluation unit, in particular the natural language processing unit, is integrated into the network, for example as software or algorithms on a server or in a data cloud. In principle, however, it is also conceivable that the evaluation unit is integrated on a local computer device, for example also in the remote interaction unit, so that no network or Internet connection to a remote server or data cloud is necessary.

The prompt is sent to the natural language processing unit, which generates a text signal processed according to the prompt content as the output signal. The output signal is sent from the evaluation unit or the network to the remote interaction unit. The output signal can be displayed, for example as text, by the remote interaction unit on a screen or display and/or output as an audio signal via a loudspeaker and/or transmitted (sent, streamed) as a wireless signal to the hearing aid or the signal processing device. The hearing aid or the signal processing device generates from the transmitted output signal, for example, a corresponding audio signal, which is output, for example after noise cancelation, to the user by the output transducer as an acoustic sound signal. The output unit is thus implemented, for example, by the remote interaction unit and/or the output transducer of the hearing aid.

In a conceivable refinement, it is possible, for example, that a specific or predefined hearing aid setting or a specific hearing aid parameter configuration is also associated with the context or each context, so that the output signal is output with modified hearing aid settings or parameters when output through the hearing aid. In other words, a hearing aid parameter or hearing aid setting is modified based on the triggered context. If the context is, for example, that the user has not correctly understood the utterance acoustically, for example, the signal gain of the signal processing device will be increased, causing the output signal to be output with an increased signal level or volume so that the user understands the information in the output signal better or more clearly.

Other features which are considered as characteristic for the invention are set forth in the appended claims.

Although the invention is illustrated and described herein as embodied in a method for operating a hearing aid system and a hearing aid system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a block diagram of a hearing aid system with a user;

FIG. 2 is a plan view of an embodiment of the hearing aid system having a hearing aid, a remote interaction unit and a network; and

FIG. 3 is a flow diagram of a method according to the invention.

### DETAILED DESCRIPTION OF THE INVENTION

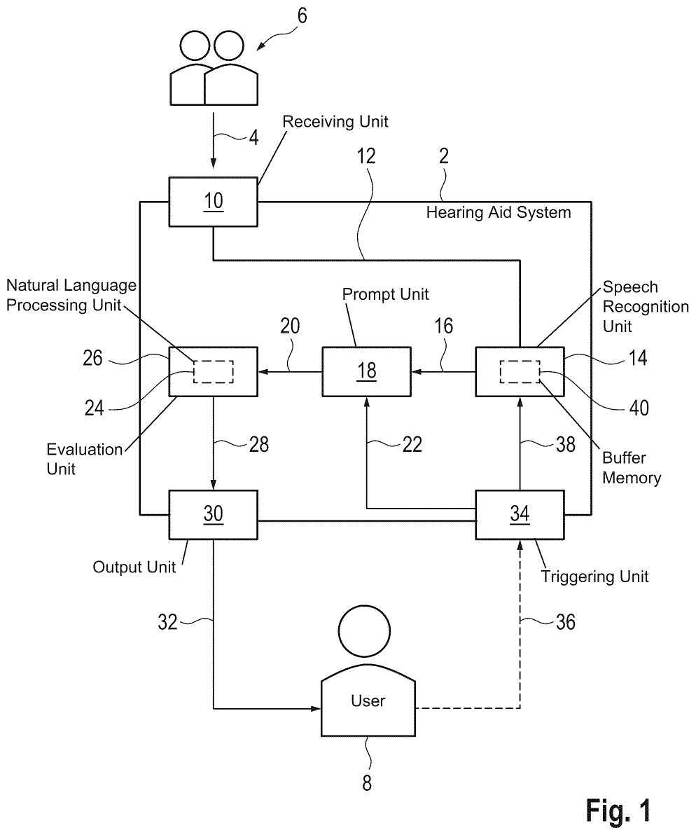

Referring now in detail to the figures of the drawings, in which equivalent parts and dimensions are provided with identical reference signs, and first, particularly, to FIG. 1 thereof, there is seen a hearing aid system 2 for improving speech intelligibility. The hearing aid system 2 is constructed and configured to process and output speech information 4 of a speech utterance in a listening or conversational situation 6 for a user 8.

The hearing aid system 2 in this case includes a receiving unit 10 for receiving the speech information 4. The receiving unit 10 is constructed and configured to receive the speech information 4 as an acoustic signal and to convert it into an electrical or digital speech signal 12.

The hearing aid system 2 further includes a speech recognition unit 14 for converting or transcribing the speech signal 12 into a text signal 16. The hearing aid system 2 additionally includes a prompt unit 18 for generating or providing a context-dependent prompt 20. In this case, the text signal 16 and a desired context 22 are preferably fed into the prompt unit 18, which generates a corresponding prompt 20 from these. The prompt 20 is, for example, a text signal containing the information of the text signal 16 and a context-dependent evaluation instruction for a natural language processing unit 24.

The natural language processing unit 24 is part of an evaluation unit 26 of the hearing aid system 2. The natural language processing unit 24 processes the information in the text signal 16 according to the evaluation instructions of the prompt 20 and generates a resulting text signal as an output signal 28. The output signal 28 is sent to an output unit 30, which outputs or transmits corresponding information 32 to the user 8.

The hearing aid system 2 has a triggering unit 34 which can be triggered by the user 8 as required. The triggering unit 34 can in this case be triggered or actuated, for example, in response to at least one trigger type 36, wherein each trigger type 36 is associated with a different stored context 22. Preferably, the triggering unit 34 is able to be triggered in response to at least two different types of trigger 36. This means that the user 8 can specify a specific context 22 for the prompt 18 by triggering the triggering unit 34 by using a specific trigger type 36.

Preferably, when the triggering unit 34 is actuated, activated or triggered, a (context-type or trigger-type-independent) trigger signal 38 is generated to activate the speech recognition unit 14. In other words, the speech recognition unit 14 preferably generates the text signal 16 only when it receives the trigger signal 38.

In particular, the triggering (at least implicitly) of the triggering unit 34 also provides a trigger time for the prompt unit 18 and/or speech recognition unit 14, through the use of which a time related to the text signal 16, or at least a relative indication as to how the triggering and the text signal 16 are connected, is transmitted. The prompt unit 18 thus receives as input signals the context 22, the trigger time, and the text signal 16 (if necessary with time specification). The prompt unit 18 is thus provided with information on the extent to which the time of triggering is related to a part of the speech utterance.

The hearing aid system 2 has, for example, a buffer memory 40 integrated into the speech recognition unit 14, in which the speech signal 12 is stored for a predefined period of time and substantially continuously updated in operation until the trigger signal 38 is received from the speech recognition unit 14. The speech recognition unit 14 uses the speech signal 12 stored in the buffer memory 40 for generating the text signal 16 upon receiving the trigger signal 38. The buffer memory 40 stores, for example, the last 45 s, in particular the last 15 s of the speech signal 12.

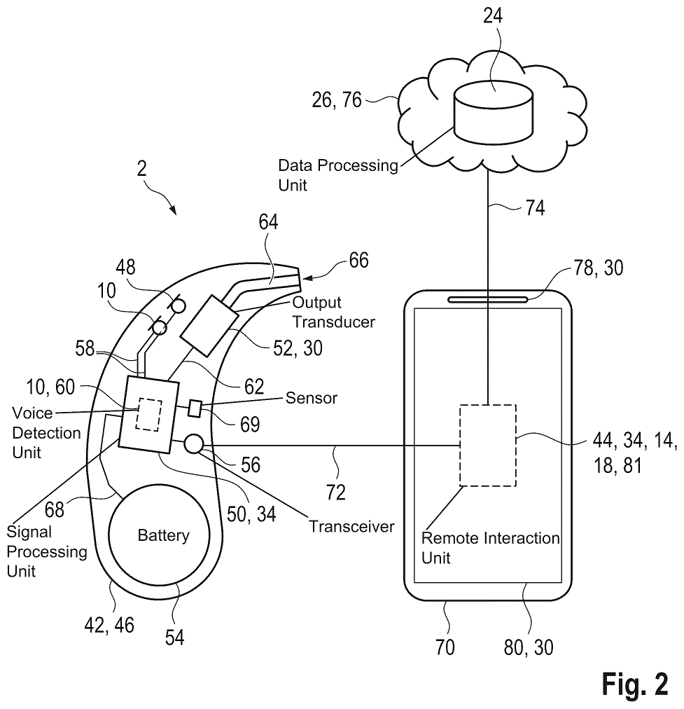

FIG. 2 shows, in a diagrammatic and simplified illustration, a hearing aid system 2 embodied as a hearing aid device, including a hearing aid 42 and a remote interaction unit 44. The hearing aid 42 in the illustrated exemplary embodiment, by way of example, is a BTE hearing aid.

The hearing aid 42 includes a (hearing aid) housing 46 to be worn behind the ear of a hearing impaired user and in which as main components two input transducers 48 in the form of microphones, a signal processing unit 50, an output transducer 52 in the form of a receiver, and a battery 54 are disposed. The hearing aid 42 further includes a transceiver 56 for, in particular, the wireless exchange of data, for example on the basis of a Bluetooth standard.

In the operation of the hearing aid 42, an ambient sound from the vicinity of the hearing aid 42 is captured by the input transducer 48 and output as an audio signal 58 (i.e. as an electrical signal carrying the sound information) to the signal processing unit 50. The audio signal 58 is processed by the signal processing unit 50. The signal processing unit 50 includes a plurality of signal processing functions for this purpose, including an amplifier, which amplifies the audio signal 58 in a frequency-dependent manner to compensate for the hearing impairment of the user. The signal processing unit 50 has a voice detection unit (VAD) 60, through the use of which spoken sections of speech or speech information 4 in the audio signal 58 can be identified and separated. The input transducer 48 and the signal processing unit 50 or the speech recognition unit 60 form the receiving unit 10 of the hearing aid system 2.

The signal processing unit 50 outputs an audio signal 62 resulting from this signal processing to the output transducer 52. This in turn converts the audio signal 62 into an acoustic sound. This sound (modified in relation to the captured ambient sound) is directed from the output transducer 62 first through a sound channel 64 to a tip 66 of the housing 46, and from there through a (not explicitly illustrated) sound tube to an earpiece that can be inserted or is inserted into the user's ear.

The signal processing unit 50 is supplied with electrical power 68 by the battery 54.

The signal processing unit 50 is coupled for signal transmission to a sensor 69 of the hearing aid 42.

In a conceivable embodiment, the sensor 69 is configured, for example, as a movement sensor for detecting body movements of the (hearing aid) user. The movement sensor 69 is constructed and configured to detect a body part, in particular a hand or a finger, approaching the hearing aid 42, and touching of the hearing aid 42 or the device housing 46. For this purpose, the signal processing device 50 has, for example, a tap detection function, not further referenced, which processes the sensor signals of the movement sensor 69 with regard to recognizing or detecting a tapping movement or tapping gesture of the user 8 and generates corresponding control signals, which are transmitted, for example, via the transceiver 56 to the remote interaction unit 44 in order to trigger a desired device function.

Alternatively, the sensor 69 may also be configured as a physiological sensor 69. The output signal 28, in particular the audio signal 62 can be adjusted by using sensor data of the physiological sensor 69. In addition or alternatively, the sensor data from the physiological sensor 69 in the signal processing unit 50 is compared with a stored threshold value, wherein the triggering unit 34 is triggered when the threshold value is reached or exceeded, as the trigger type 36.

The remote interaction unit 44 in the illustrated exemplary embodiment is implemented as software in the form of a (smartphone) app which is installed on a smartphone 70. The smartphone 70 can be a smartphone belonging to the hearing aid user. The smartphone 70 is not itself a component of the hearing aid system 2 and is used by it purely as a resource. Specifically, the remote interaction unit 44 uses memory space and computing power of the smartphone 70 for carrying out a method described in the following for operating the hearing aid system 2 or the hearing aid 42. Furthermore, the remote interaction unit 44 uses a Bluetooth transceiver (not shown in detail) of the smartphone 70 for wireless communication, i.e. for data exchange with the hearing aid 42 via a wireless signal or communication link 72 (Bluetooth link) indicated in FIG. 2 to the transceiver 56.

Through a further wireless or wired data communication link 74, for example based on the IEEE 802.11 standard (WLAN) or a mobile radio standard, e.g. LTE, the remote interaction unit 44 is further connected to a network, or to a data cloud (cloud) 76 disposed on the Internet, in which the natural language processing unit 24 is installed or integrated. The data processing unit 24 can also be integrated on a server connected to the data cloud 76. The evaluation unit 26 of the hearing aid system 2 is formed by the data cloud 76 or the server. For data exchange with the data processing unit 24, the remote interaction unit 44 accesses a (also not explicitly shown) WLAN or mobile radio interface of the smartphone 70.

The smartphone 70 also includes a loudspeaker 78 and a display screen in the form of a touchscreen 80. The loudspeaker 78 and/or the screen 80 are used by the remote interaction unit 44 as input and/or output devices for the user 8.

The functionality of the speech recognition unit 14 and the prompt unit 18 is integrated into the remote interaction unit 44 or the app. The remote interaction unit 44 receives the speech signal 12 transmitted via the communication link 72 and sends the prompt 20 via the communication link 74 to the data cloud 76. The output signal 28 generated by the natural language processing 24 is sent via the communication link 74 to the remote interaction unit 44 and optionally on to the hearing aid 42 via the communication link 72.

The triggering unit 34 is formed by user interfaces of the hearing aid system 2 with the user 8. For example, the triggering unit 34 is at least partially implemented by the remote interaction unit 44, in particular the contexts are stored in the remote interaction unit 44. The triggering unit 34 is also realized in this embodiment, for example, by the movement sensor 69 or the tap detection of the signal processing unit 50. In addition, for example, a tapping gesture by the user 8, that is, a tap on the device housing 46 with a finger, can be defined as a trigger type, wherein the corresponding tap information is transmitted via the communication link 72 to the remote interaction unit 44. Another type of triggering can be implemented, for example, by touching the screen 80 configured as a touchscreen or by optical evaluation of a gesture by the user 8 by using a camera of the smartphone 70, not shown in detail.

The output unit 30 in this embodiment is implemented, for example, by the output transducer 52 and/or by the remote interaction unit 44, in particular via the loudspeaker 78 and/or the screen 80.

In the signal processing unit and/or in the remote interaction unit 44 and/or the prompt unit 18, for example, a hearing profile 81 for the user 8 is stored, wherein the prompt 20 (or the context 22) can be generated in accordance with the hearing profile 81.

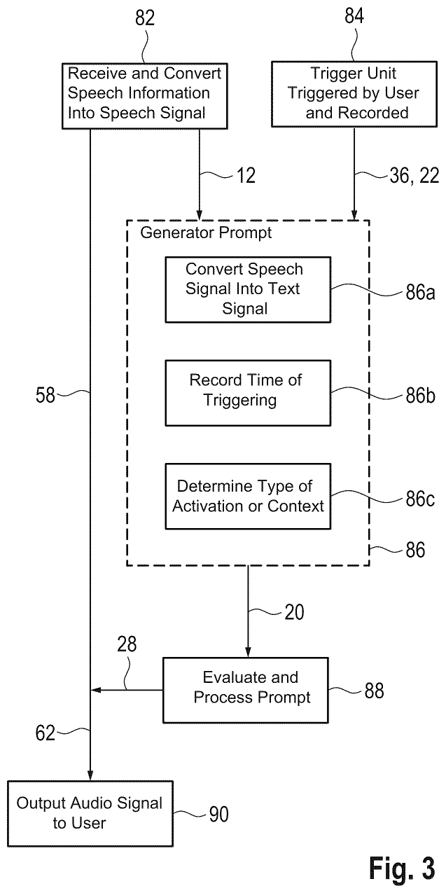

In the following a method for operating the hearing aid system 2, which is configured as a hearing device, is explained in more detail with reference to FIG. 3.

In method step 82, the speech information 4 is received and converted into the speech signal 12 via the receiving unit 10. For example, the speech information 4 is received via the input transducers 48 and separated or filtered from the audio signal 58 by the voice activity detection 60. Alternatively, the speech information 4 can also be transmitted by the smartphone 70 via radio, for example via the communication link 72 (streaming).

If in a method step 84 the triggering unit 34 is triggered by the user 8 by a trigger type 36, the trigger type 36—and the associated context 22—and the trigger time are recorded. For example, the user 8 taps the device housing 46, and thus triggers a processing or evaluation of the speech signal 12 intended to improve the content-based speech comprehension. The gist of the context 22 can therefore be expressed in basic terms, for example as a short question or statement, which indicates an insufficient understanding of the content (“Eh?,” “What?,” “Please rephrase,” . . . ).

In method step 86, the prompt 20 is generated. For this purpose, the speech signal 12 is first converted by the speech recognition unit 14 into the text signal 16 (method step 86a). Furthermore, the time of triggering is recorded in absolute or relative terms (method step 86b) and the type of activation or the context is determined (method step 86c). The prompt unit 20 processes the text signal 16 and the context 22 according to the trigger time to form the prompt 20, which is transmitted via the communication link 74 to the natural language processing unit 24.

In addition to the trigger type 36, for example, health or hearing aid data (fitting configuration/parameters) or data/information about the user (e.g. age, education, vocabulary, peculiarities of speech comprehension, etc.) are used as the context, all of which are stored in the hearing aid system 2.

The following shows a piece of pseudo-code for the exemplary creation of a prompt 20 (“prompt”), in which the prompt for the natural language processing 24 is generated from the text signal 16 (“utterance”), the trigger time (“trigger_time”) and the context 22 (“problem,” “user_properties”):

```
“user_properties = [ “age: 42 years,”
  “profession: engineer,”
  “vocabulary: below average,”
  “has trouble to understand complex sentences,”
  ″has trouble to understand words with the consonant ″k″′]
utterance = “The horse trotted around the field at a brisk pace.”
trigger_time = ″pace″
intelligibilities = [[“brisk,” “before,” “good″], [“brisk,” “after,” “bad″]] # e.g.
determined from EEG measurements
problem = ″generic understanding problem (″huh?″)″
prompt = ″Dear Large Language Model, we are a hearing aid company and we
received a request from one of our customers with the following properties:“
for property in user properties:
    prompt += ″\n- ″ + property
prompt += ″\n\nThe request is related to a sentence that the user listened to: \ +
utterance + ″\
prompt += ″\n\nThe user indicated a problem in hearing or understanding the
above sentence. We have the following information:″
prompt += ″\n- at the time of the word \″″ + trigger_time + ″\″ a ″ + problem + ″
was indicated by the user (i.e., immediately before the user experienced a
problem).″
for intelligibility in intelligibilities:
  keyword = intelligibility[9] # reference time
  reference = intelligibility[1] # before/after
  quality = intelligibility[2] # speech comprehension good/bad
if reference == ″before″:
  hint = “Until the word ″
  else:
  hint = “After the word ″
hint += ″\″″ + keyword + ″\″ the speech comprehension was “ + quality + .”″
prompt += ″\n- + hint
prompt += ″\n\n Please give us an answer that we can whisper to the user to
inform them about the incomprehensible contents.
  The answer must be very brief (1-3 words) and should help the user to
  drop back into the conversation.
  You are welcome to paraphrase and abbreviate the relevant part of the
  sentence to make it more comprehensible.”
```

The trigger time (“trigger_time”) is characterized by a section or word of the test signal 16 at the trigger time. In the exemplary embodiment, the text signal 16 is, for example, “The horse trotted around the field at a brisk pace,” wherein the triggering unit 34 was triggered at the time when the word “pace” was spoken/transcribed. In other words, according to the method, the trigger time of the trigger type 36 is preferably associated with the content of the text signal 16, for example, by determining a position or a section of the text signal 16 which was spoken at the trigger time. For the prompt generation, a portion or section of the text signal 16 is thus determined as a measure of the trigger time, and used for the prompt 20.

In this exemplary embodiment, the trigger time is, for example, at the end of a sentence, but the trigger time may also be in the middle or at the beginning of a spoken sentence, wherein for the prompt 20 the entire sentence is preferably used as a text signal 16. Furthermore, sentences spoken before or after this point can also be taken into account for the prompt 20 or for the evaluation. This can be specified using the context 22, for example.

The context 22 for creating the prompt 20 includes a context linked to the trigger type 36 (“problem”), stored user data (“user_properties”) and a speech comprehension (“intelligibility”) determined by sensor measurements of the sensor 69 (for example EEG).

For example, the user data can be used to define the user as a 42-year-old engineer with below-average vocabulary who has difficulty understanding complex sentences and words with the consonant “k.” This information is taken into account in the prompt 20 or for the evaluation by the natural language processing unit 24.

The context of the trigger type 36 in this case is a general understanding problem (“generic understanding problem (“huh? “)”). Based on the sensor measurements or sensor data it is determined, for example, at which time, i.e. at which point of the text signal 16 (“keyword”) comprehension problems have occurred, so that in particular the part of the text signal 16 not understood is prepared for the user 8. In the exemplary embodiment, comprehension problems have occurred after the word “brisk.”

For example, the following text is generated as a prompt 22 for the above pseudo code:

“Dear Large Language Model, we are a hearing aid company and we received a request from one of our customers with the following properties:
age: 42 years
profession: engineer
Vocabulary: below average
has trouble io understand complex sentences
has trouble to understand words with the consonant ‘k’

The request is related to a sentence that the user listened to: “The horse trotted around the field at a brisk pace.”

The user indicated a problem in hearing or understanding the above sentence. We have the following information:
at the time of the word “pace” a generic understanding problem (huh?) was indicated by the user (i.e., immediately before the user experienced a problem).
Until the word “brisk” the speech comprehension was good.
After the word “brisk” the speech comprehension was bad.

Please give us an answer that we can whisper to the user to inform them about the incomprehensible contents. The answer must be very brief (1-3 words) and should help the user to drop back into the conversation. You are welcome to paraphrase and abbreviate the relevant part of the sentence to make it more comprehensible.”

Below, a second piece of pseudo-code for another trigger type 36 is shown, wherein the context of the trigger type 36 is, for example, a problem of understanding a number or a date, wherein only the relevant number or the date is to be repeated (“understanding problem related to a number or a date (i.e., ONLY repeat the misunderstood number”). The text signal 16 in this exemplary embodiment is “Yet, despite all the advances in medical technology, the diagnosis of brain disorders in one in six children still remained so limited.” The user 8 is a 42 year-old engineer with above average vocabulary and limited hearing.

```
“user_properties = [ “age: 42 years,”
  “profession: engineer,”
  “vocabulary: above average,”
  “has an impaired sense of hearing″]
utterance = “Yet, despite all the advances in medical technology, the diagnosis
of brain disorders in one in six children still remained so limited.”
trigger_time = ″children″
intelligibilities = [[“disorders,” “before,” “good″], [“disorders,” “after,” “bad″],
[″children,” “after,” “good”]] # e.g. determined from EEG measurements
problem = “understanding problem related to a number or a date (i.e., ONLY
repeat the misunderstood number!)″
prompt = ″Dear Large Language Model, we are a hearing aid company and we
received a request from one of our customers with the following properties: “
for property in user properties:
    prompt += ″\n- ″ + property
prompt += ″\n\nThe request is related to a sentence that the user listened to: \ +
utterance + ″\
prompt += ″\n\nThe user indicated a problem in hearing or understanding the
above sentence. We have the following information:″
prompt += ″\n- at the time of the word \″″ + trigger_time + ″\″ a ″ + problem + ″
was indicated by the user (i.e., immediately before the user experienced a
problem).″
for intelligibility in intelligibilities:
  keyword = intelligibility[9] # reference time
  reference = intelligibility[1] # before/after
  quality = intelligibility[2] # speech comprehension good/bad
if reference == ″before″:
  hint = “Until the word ″
  else:
  hint = “After the word ″
hint += ″\″″ + keyword + ″\″ the speech comprehension was “ + quality + .”″
prompt += ″\n- + hint
prompt += ″\n\n Please give us an answer that we can whisper to the user to
inform them about the incomprehensible contents.
  The answer must be very brief (1-3 words) and should help the user to
  drop back into the conversation.
```

You are welcome to paraphrase and abbreviate the relevant part of the sentence to make it more comprehensible.”
The resulting prompt 20 is:
   “Dear Large Language Model, we are a hearing aid company and we received a request from any of our customers with the following properties:
age: 42 years
profession: engineer
vocabulary: above average
has an impaired sense of hearing

The request is related to a sentence that the user listened to: “Yet, despite all the advances in medical technology, the diagnosis of brain disorders in one in six children still remained so limited.”

The user indicated a problem in hearing or understanding the above sentence. We have the following information:
at the time of the word “children” an understanding problem related to a number or a date (Le, ONLY repeat the misunderstood number) was indicated by the user (i.e., immediately before the user experienced a problem).
Until the word “disorders” the speech comprehension was good.
After the word “disorders” the speech comprehension was bad.
After the word “children” the speech comprehension was good.

Please give us an answer that we can whisper to the user to inform them about the incomprehensible contents. The answer must be very brief (1-3 words) and should help the user to drop back into the conversation. Just provide the direct speech that should be forwarded to the user, without further commenting.”

In a method step 88, the prompt 20 is evaluated and processed by the natural language processing unit 24. The natural language processing unit 24 generates the output signal 28, which is, for example, a text signal with the keywords contained in the speech signal 12, with the keywords being paraphrased.

The output signal 28 is sent to the remote interaction unit 44, which converts the text signal, for example by using a text-to-speech function, into an audio signal which is transmitted to the hearing aid 42. In the signal processing unit 50, the output signal 28 or the audio signal generated from it is optionally amplified and superimposed, for example, with the processed or modified audio signal 58 into the audio signal 62, which is acoustically output to the user 8 in the method step 90. Thus, the user 8 hears the paraphrased keywords of the past speech signal 12 as information 32, so that they can better follow the conversational situation 6.

If, for example, as context 22, an acoustic speech comprehension of the type “Please repeat” is triggered or predefined, the natural language processing unit 24 generates, for example, an output signal 28 which corresponds to the content of the text signal 16, or which is composed of one or more sections of the text signal 16 considered important or relevant. The output signal 28 is converted, for example by using text-to-speech, into an audio signal, so that the speech signal 12 or one or more sections thereof are effectively played back to the user 8.

The claimed invention is not limited to the exemplary embodiments described above. Instead, other variants of the invention can also be derived from them by a person skilled in the art, without departing from the subject matter of the claimed invention. In particular, all individual features described in connection with the various exemplary embodiments within the disclosed claims can also be combined together in different ways without departing from the subject matter of the invention.

The following is a summary list of reference numerals and the corresponding structure used in the above description of the invention:
2 hearing aid system
4 speech information
6 conversational situation
8 user
10 receiving unit
12 speech signal
14 speech recognition unit
16 text signal
18 prompt unit
20 prompt
22 context
24 data processing
26 evaluation unit
28 output signal
30 output unit
32 information
34 triggering unit
36 trigger type
38 trigger signal
40 buffer memory
42 hearing device
44 remote Interaction unit
46 device housing
48 input transducer
50 signal processing unit
52 output transducer
54 battery
56 transceiver
58 audio signal
60 speech activity unit
62 audio signal
64 sound channel
66 tip
68 power
69 sensor
70 smartphone
72 communication link
74 communication link
76 data cloud
78 loudspeaker
80 display screen/touchscreen
81 hearing profile
82 method step
84 method step
86 method step
86a, b, c method step
88 method step
90 method step

1. A method for operating a hearing aid system, the method comprising:
using a receiving unit for receiving speech information and converting the speech information into a speech signal;
using a speech recognition unit for converting the speech signal into a text signal;
using a prompt unit for generating a context-dependent prompt for a natural language processing unit;
using a triggering unit for triggering the prompt unit as required and specifying a stored context;
using an evaluation unit for evaluating the prompt by using the natural language processing unit and for generating an output signal;
using an output unit for outputting the output signal to a user; and
upon triggering the triggering unit:
a) converting at least one section of the speech signal into a text signal by using the speech recognition unit,
b) generating the prompt for the natural language processing unit by using the stored context and the text signal,
c) using the natural language processing unit to generate the output signal based on the prompt, and
d) using the output unit to output the output signal.

2. The method according to claim 1, which further comprises triggering the triggering unit by using at least two different trigger types each being linked to a different, stored, context, and generating the prompt for the natural language processing unit depending on the trigger type.

3. The method according to claim 2, which further comprises using a gesture of a hearing aid system user as at least one of the trigger types.

4. The method according to claim 1, which further comprises generating a section of the speech signal or a combination of at least two sections of the speech signal as the output signal.

5. The method according to claim 1, which further comprises storing a hearing profile for a user of the hearing aid system, and generating the prompt in dependence on the hearing profile.

6. The method according to claim 1, which further comprises using a physiological sensor for acquiring information about a bodily state of a user of the hearing system and outputting sensor data, and at least one of:
adjusting the output signal by using the sensor data from the physiological sensor, or
comparing the sensor data from the physiological sensor with a stored threshold value, and triggering the triggering unit upon reaching or exceeding the threshold value.

7. The method according to claim 1, which further comprises storing and substantially continuously updating the speech signal over a predetermined period of time during operation until the triggering unit is triggered, and using the stored speech signal by the speech recognition unit.

8. The method according to claim 1, which further comprises paraphrasing at least one section of the text signal for the output signal in a course of natural language processing.

9. The method according to claim 1, which further comprises acoustically outputting the output signal to the user.

10. A hearing aid system, comprising:
a receiving unit for receiving speech information and converting the speech information into a speech signal;
a speech recognition unit for converting the speech signal into a text signal;
a prompt unit for generating a context-dependent prompt;
a natural language processing unit for receiving the context-dependent prompt;
a triggering unit for triggering said prompt unit as required and specifying a stored context;
an evaluation unit for evaluating the prompt by using said natural language processing unit and for generating an output signal; and
an output unit for outputting the output signal to a user.
